(19) United States
(12) Patent Application Publication
(10) Pub. No.: US 2026/0307901 A1
(43) Pub. Date: Oct. 8, 2026

(54) Platform unit and storage system including the same.

(71) Applicant: Sami-Akram Mahriche, Laval (CA)

(72) Inventor: Sami-Akram Mahriche, Laval (CA)

(21) Appl. No.: 19/577,249

(22) Filed: Mar. 24, 2026

(30) Foreign Application Priority Data
Apr. 2, 2025 (GB) 2504969.3

(51) Int. Cl. B65G 1/133; B65G 39/02

(52) U.S. Cl. CPC B65G 1/133; B65G 39/025; B65G 2207/34

(57) ABSTRACT

A platform unit for handling items, comprising: a controller; a base; a plurality of elongated conveyor components mounted to the base substantially parallel to each other and defining a first direction extending longitudinally relative to the conveyor components, the conveyor components being operative for selectively moving the items parallel to the base along the first direction, each conveyor component being rotatable about a component rotation axis extending longitudinally relative thereto; wherein the conveyor components are further operative for selectively moving the items parallel to the base along a second direction substantially perpendicular to the first direction when the conveyor components rotate about the component rotation axes; and wherein the controller is operative for selectively activating the conveyor components to move the items in the first and second directions on each of the platform units.

### FIELD OF THE INVENTION

The present invention relates to the general field of storage, and is more particularly concerned with a platform unit and a storage system including the same.

### BACKGROUND

Automated three-dimensional storage structures, automated conveyor lines and autonomous handling vehicles are well known in the field of large storage and handling facilities of goods such as the ones used in the online shopping industry, in air freight shipping facilities in airports, in large and fully automated manufacturing facilities, and the likes. Currently used storage systems have many disadvantages. For example, these system typically use different automation technologies at a given location, and they generally do not share a large percentage of common automation components and parts for maintaining these systems in operating order. Thus, a relatively large and costly in-facility store for maintenance components is generally needed. Furthermore the installation costs of such different technologies in a same storage and handling facility generally imply additional costs attributed to the installation or custom developments of interface systems for enabling an integrated and fluid circulation of goods between the differently configured storage structures, conveyor lines, handling vehicles, and transport loading docks. Further operational costs must be attributed for training the warehouse personnel, and also for training, or otherwise hiring specialized maintenance personnel for keeping these automated system in operating order.

Thus, there is a need on the market for an improved storage system that avoids the aforementioned disadvantages. An object of the present invention is therefore to provides such systems.

### SUMMARY OF THE INVENTION

In a broad aspect, there is provided a storage system for handling items, comprising: a plurality of platform units provided substantially adjacent and substantially coplanar relative to each other; and a control system; each platform unit including a base; a plurality of elongated conveyor components mounted to the base substantially parallel to each other and defining a first direction extending longitudinally relative to the conveyor components, the conveyor components being operative for selectively moving the items parallel to the base along the first direction, each conveyor component being also rotatable about a component rotation axis extending longitudinally relative thereto; wherein the conveyor components are further operative for selectively moving the items parallel to the base along a second direction substantially perpendicular to the first direction when the conveyor components rotate about the component rotation axes; wherein the control system is operative for selectively activating the conveyor components to move the items in the first and second directions on each of the platform units; whereby the items can be selectively moved between the platform units by moving the items between adjacent ones of the platform units using the conveyor components.

There may also be provided a storage system wherein each conveyor component includes a plurality of conveyor wheels longitudinally spaced apart from each other and each rotatable about a respective wheel rotation axis extending laterally to move the item along the first direction, the wheel rotation axes in each conveyor component being substantially parallel to each other.

There may also be provided a storage system further including a wheel transmission coupling the conveyor wheels to each other for joint rotation about their respective wheel rotation axes.

There may also be provided a storage system wherein each conveyor component further includes a component actuator operatively coupled to the wheel transmission and to the control system for rotating the conveyor wheels about their respective wheel rotation axes when powered by the control system.

There may also be provided a storage system wherein the wheel transmission includes a belt and the wheels are configured to engage the belt so as to be rotatable thereby.

There may also be provided a storage system wherein the conveyor wheels have a generally spherical configuration.

There may also be provided a storage system wherein the conveyor wheels each include two substantially hemispherical wheel portions defining a gap therebetween, the gap containing a gear.

There may also be provided a storage system wherein each platform unit further includes a component transmission coupling the conveyor components to each other for joint rotation about their respective component rotation axis.

There may also be provided a storage system wherein each platform unit further includes a unit actuator operatively coupled to the component transmission and to the control system for rotating the conveyor component about their respective component rotation axes when powered by the control system.

There may also be provided a storage system wherein the unit transmission includes a toothed belt engaging component gears, each component gear being rotatable about a respective one of the component rotation axes and jointly rotatable thereabout with a respective one of the conveyor components.

There may also be provided a storage system wherein the storage system includes assemblies including four of the platform units arranged adjacent to each other in an array with the longitudinal axes of the conveyor components of each platform unit orthogonal to the longitudinal axes of the conveyor components of contiguous ones of the four platform units.

In another broad aspect, there is provided a platform unit for handling items, comprising: a controller; a base; a plurality of elongated conveyor components mounted to the base substantially parallel to each other and defining a first direction extending longitudinally relative to the conveyor components, the conveyor components being operative for selectively moving the items parallel to the base along the first direction, each conveyor component being rotatable about a component rotation axis extending longitudinally relative thereto; wherein the conveyor components are further operative for selectively moving the items parallel to the base along a second direction substantially perpendicular to the first direction when the conveyor components rotate about the component rotation axes; and wherein the controller is operative for selectively activating the conveyor components to move the items in the first and second directions on each of the platform units.

There may also be provided a platform unit wherein each conveyor component includes a plurality of conveyor wheels longitudinally spaced apart from each other and each rotatable about a respective wheel rotation axis extending laterally to move the item along the first direction, the wheel rotation axes in each conveyor component being substantially parallel to each other.

There may also be provided a platform unit further including a wheel transmission coupling the conveyor wheels to each other for joint rotation about their respective wheel rotation axes.

There may also be provided a platform unit wherein each conveyor component further includes a component actuator operatively coupled to the wheel transmission and to the controller for rotating the conveyor wheels about their respective wheel rotation axes when powered by the controller.

There may also be provided a platform unit wherein the wheel transmission includes a belt and the wheels are configured to engage the belt so as to be rotatable thereby.

There may also be provided a platform unit wherein the conveyor wheels have a generally spherical configuration.

There may also be provided a platform unit wherein the conveyor wheels each include two substantially hemispherical wheel portions defining a gap therebetween, the gap containing a gear.

There may also be provided a platform unit wherein each platform unit further includes a component transmission coupling the conveyor components to each other for joint rotation about their respective component rotation axes.

There may also be provided a platform unit wherein each platform unit further includes a unit actuator operatively coupled to the component transmission and to the controller for rotating the conveyor components about their respective component rotation axes when powered by the controller.

There may also be provided a platform unit wherein the component transmission includes a toothed belt engaging component gears, each component gear being rotatable about a respective one of the component rotation axes and jointly rotatable along with a respective one of the conveyor components.

Multiple platform units of the present invention may be advantageously used throughout a fully automated storage and distribution warehouse. Further advantageously, the use of the same platform unit throughout the warehouse consequently significantly reduces overall costs associated with spare parts, general maintenance, and training of employees operating the warehouse, comparatively to known automated equipment typically used for automating distribution warehouses and the like. In addition, the proposed platform unit is mechanically relatively simple and easily controllable due to the fixed orthogonal movement axes, when compared to prior art platform units that may include components rotable about an axis that is perpendicular to the conveyor units unit.

The present invention claims priority from UK patent application 2504969.3 filed Apr. 2, 2025, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a platform unit according to the present invention;

FIG. 2, in a top plan view, illustrates the platform unit in FIG. 1;

FIG. 3, in a side elevational view, illustrates the platform unit in FIG. 1;

FIG. 4, in a perspective view, illustrates a conveyor component part of the platform unit of FIG. 1;

FIG. 5, in a perspective, exploded view, illustrates the conveyor component of FIG. 4;

FIG. 6, in a perspective, exploded view, illustrates a component axial rotation arrangement and a conveyor component all part of the platform unit of FIG. 1;

FIG. 7, in a schematic view, illustrates a control system usable to control a storage system including platform units similar to the platform unit of FIG. 1;

FIG. 8, in a perspective view, illustrates a multidirectional intersection represented by a plurality of assemblies of four platform units of FIG. 1;

FIG. 9, in a perspective view; illustrates an automated platform of the prior art, here shown mounted in a three-dimensional racking structure provided with automated mobile lifts, as well as used as autonomous transport vehicles;

FIG. 10, in a perspective view, illustrates a bi-level automated platform unit of the prior art, here shown actuated through four independent hydraulic or air actuated telescopic cylinders. The telescopic cylinders are capable of performing level as well as inclined lifting actions on shipping boxes, warehouse palettes and the likes;

FIG. 11, in a perspective view, illustrates an autonomous automated platform of the prior art, here shown mounted on four drive wheels; and

FIG. 12, in a side cutaway view, illustrates a loading dock interface between a storage racking structure in a warehouse and a storage racking structure in the cargo bay of a transport truck, wherein an automated platform unit of the prior art is used as a support surface throughout all the raking and shelves levels illustrated.

### DETAILED DESCRIPTION

The terms “substantially” and “about” are used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention.

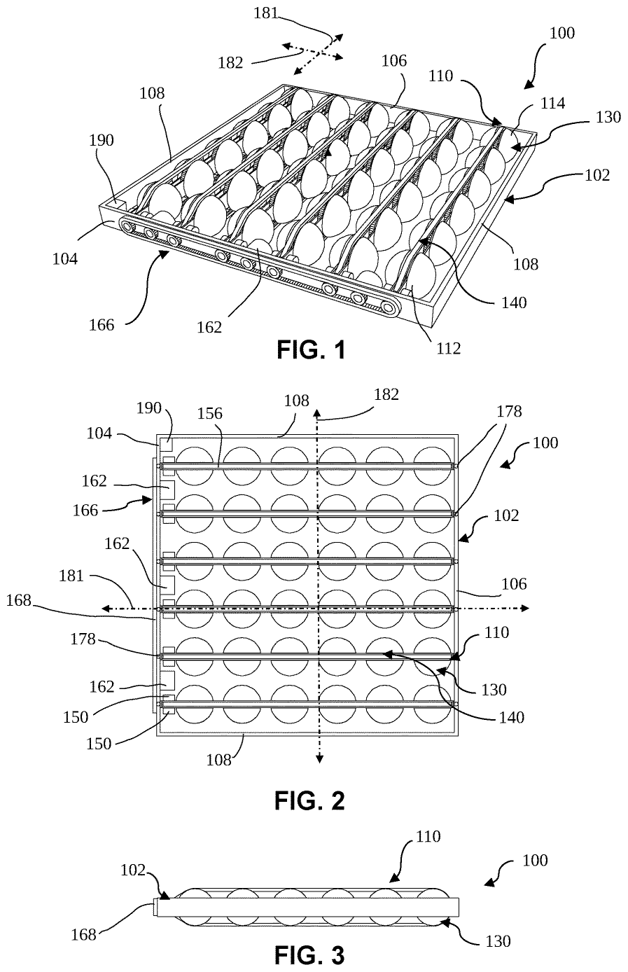

FIGS. 1 to 8 illustrates various aspects of an embodiment, according to the present invention, of a platform unit 100. The platform unit 100 is usable for automating storage, handling and transport of goods.

Referring collectively to FIGS. 1 and 2, the platform unit 100 comprises a base taking here the form of a platform frame 102. The platform frame 102 typically has a substantially square or rectangular configuration, and includes parallelly spaced apart front and rear frame members 104 and 106, and parallelly spaced apart frame side members 108 joining the front and rear frame members 104 and 106 to each other.

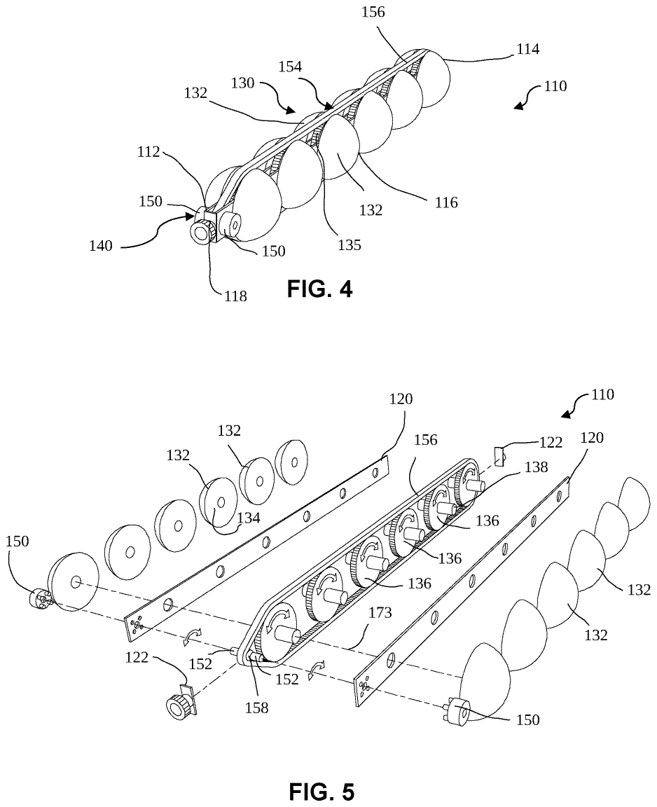

The platform unit 100 further comprises a plurality conveyor components 110 mounted to the platform frame 102 substantially parallel to each other. Referring to FIGS. 4 and 5 collectively, the conveyor components 110 have a substantially elongated configuration and define conveyor component first and second end portions 112 and 114 and a conveyor component intermediate portion 116 extending longitudinally between the conveyor component first and second end portions 112 and 114.

Referring to FIGS. 1 and 2, each of the conveyor components 110 of the platform unit 100 have their opposed conveyor component first and second end portions 112 and 114 rotably mounted in a respective one of the front and rear frame members 104 and 106 of the platform frame 102, so as to be extending in a substantially parallelly and equidistantly spaced apart relationship therein.

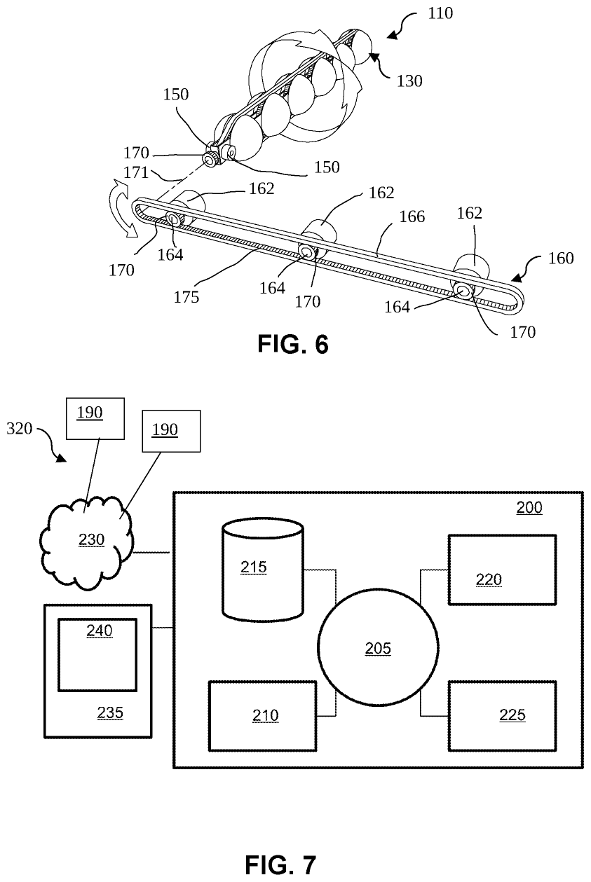

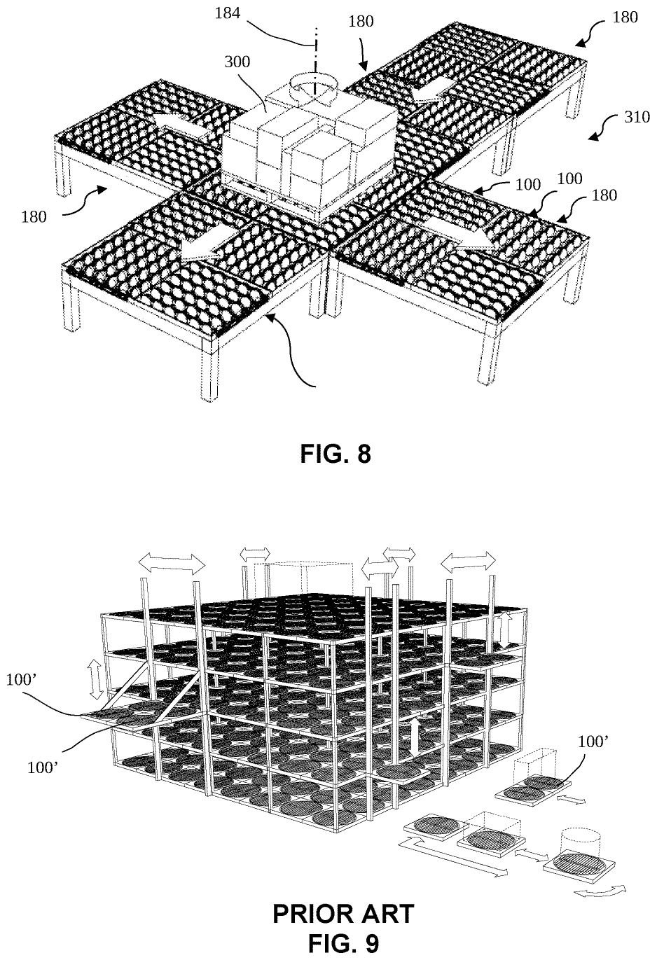

The conveyor components 110 define a first direction 181 extending longitudinally relative to the conveyor components 110. The conveyor components 110 are operative for moving items 300 (seen in FIG. 8) parallel to the base along the first direction 181. Each conveyor component 110 is also pivotable about a component rotation axis 171 (seen for example in FIG. 6) extending longitudinally relative thereto. The conveyor components 110 are further operative for moving the items 300 parallel to the base along a second direction 182 substantially perpendicular to the first direction 181 when the conveyor components 110 pivot about the component rotation axes 171.

The conveyor component 110 each include a plurality of conveyor wheels 130 longitudinally spaced apart from each other and each rotatable about a respective wheel rotation axis 173 (seen in FIG. 5) extending laterally to move the item 300 along the first direction 181. To that effect, the wheel rotation axes 173 within each conveyor component 110 are substantially parallel to each other.

Referring collectively to FIGS. 4 and 5, the conveyor wheels 130 are supported by a conveyor wheel support frame 118. The conveyor wheel support frame 118 typically has a substantially elongated rectangular configuration and may be for example defined by a pair of substantially elongated rectangular and parallelly spaced apart conveyor wheel support members 120 joined at each opposite end thereof by a pair of conveyor wheel support frame end portion 122.

The conveyor wheel 130 has a substantially spherical shape configuration. For example, each conveyor wheel 130 is defined by a pair of substantially hemispherical portions 132 having their respective planar surfaces 134 oppositely facing one another in a spaced apart relationship relative to each other and joined to one another via a gear taking for example the form of a co-planar disk-shaped intermediate portion 136 provided in a gap 135 between the planar surfaces 134.

The conveyor wheel 130 further includes a conveyor wheel support axle 138 extending coaxially transversally an imaginary central axis extending through the disk-shaped intermediate portion 136 and the apex of each hemispherical portions 132. The conveyor wheels 130 of the conveyor component 110 are each rotably mounted via their respective conveyor wheel support axle 138 in an equidistantly spaced apart relationship relative to one another along and between the pair of conveyor wheel support members 120 of the conveyor wheel support frame 118.

It is to be noted that each conveyor wheel 130 may be represented by a suitable mechanical assembly of individual components as described above, or a single piece element manufactured using a suitable injection molding process well known in the manufacturing industry.

The conveyor component 110 further includes a component actuator 140. The component actuator 140 is operatively coupled to the conveyor wheels 130 for jointly rotating about their conveyor wheel support axles 138 the conveyor wheels 130 within each conveyor component 110. The component actuator 140 is capable of concurrently rotating each conveyor wheel 130 in either one of a forward and a reverse direction.

In some embodiments of the invention, the component actuator 140 includes at least one electrically powered wheel actuator motor 150 connected to one of the conveyor wheel support frame end portion 122 and having a motor output driveshaft 152. The component actuator 140 further includes a wheel rotation transmission arrangement 154 operatively mounted between the motor output driveshaft 152 and the disk-shaped intermediate portion 136 of each conveyor wheel 130 of the conveyor component 110, forming a wheel transmission coupling the conveyor wheels 130 to each other for joint rotation about their respective conveyor wheel support axles 138.

The wheel rotation transmission arrangement 154 is for example represented by a spur gears and toothed belt arrangement 156, as best illustrated in FIGS. 4 and 5, with the toothed belt engaging the gears formed by the disk-shaped intermediate portion 136. It is to be understood that the wheel rotation transmission arrangement 154 may just as well be represented by a pulleys and V-belt arrangement, a sprockets and chain link arrangement, or a spur gear and an endless screw drive arrangement (not shown in the figures), among other possibilities.

Referring more to FIG. 5, the spur gears in the transmission arrangement are represented by, respectively, one spur gear 158 mounted on the motor output driveshaft 152, and each of the disk-shaped intermediate portion 136 defines a toothed periphery 158.

If the wheel rotation transmission arrangement 154 includes an endless screw (not shown in the figures), the latter extends longitudinally parallelly relative to the pair of conveyor wheel support members 120 and between the pair of hemispherical portions 132 of each conveyor wheel 130, so as to operatively engage the disk-shaped intermediate portion 136 thereof defining a toothed periphery 158.

In some embodiments of the invention wherein relatively heavy parcel boxes, palettes, etc., are transported by the platform unit 100, the component actuator 140 includes a pair of wheel actuator motors 150 mounted in opposition at one of the conveyor wheel support frame end portion 122, as illustrated in the figures. However, a single wheel actuator motor 150 may be used in some embodiments of the invention. In other embodiments of the conveyor component 110, the latter includes a pair of wheel actuator motors 150 mounted at each of the conveyor wheel support frame end portion 122, with the wheel rotation transmission arrangement 154 suitably dimensioned and shaped accordingly.

Referring collectively to FIGS. 1, 2 and 6, the platform unit 100 further comprises a unit actuator 160 operative for rotating the conveyor components 110 about their respective component rotation axes 173. The unit actuator 160 is for example operationally mounted between at least one of the front and rear frame members 104 and 106, and a respective one of the conveyor wheel support frame end portion 122 of each conveyor component 110 in the platform unit 100. The conveyor component axial actuator 160 is capable of concurrently rotating each conveyor component 110 about their respective longitudinal axis in one of a forward and a reverse direction.

The unit actuator 160 includes at least one electrically powered component actuator motor 162 having a motor output driveshaft 164. Each one of the at least one component actuator motor 162 is connected to a respective one of the front or rear frame members 104 and 106 of the platform frame 102. The unit actuator 160 further includes a component axial rotation transmission arrangement 166 operatively mounted between the motor output driveshaft 164 of the conveyor component first and second end portions 112 and 114 rotably mounted on the platform frame 102. The component axial rotation transmission arrangement 166 is for example represented by a spur gears 170 and toothed belt 175 arrangement, as best illustrated in FIG. 6. It is to be understood that the component axial rotation transmission arrangement 166 may just as well be represented by a pulleys and V-belt arrangement, a sprockets and chain link arrangement, or a spur gear and an endless screw drive arrangement (not shown in the figures), among other possibilities.

The spur gears 170 in the transmission arrangement are represented by, respectively, one spur gear 170 mounted on the motor output driveshaft 164 of each component actuator motor 162, and a spur gear 170 coaxially mounted on a distally extending end of the respective conveyor component first or second end portions 112 and 114. If the component axial rotation transmission arrangement 166 includes an endless screw (not shown in the figures), the latter is suitably rotably mounted so as to extend longitudinally parallelly relative to the front or rear frame members 104 and 106 of the platform frame 102. In some embodiments of the invention (not shown in the figures) a component actuator motor 162 and component axial rotation transmission arrangement 160 are mounted at each opposed end of each conveyor component 110 of the platform unit 100.

A plurality of the platform units 100 may be used to form a storage system 310 for handling items 300, as seen in FIG. 8. A plurality of the platform units 100 may be provided substantially adjacent and substantially coplanar relative to each other. The storage system 310 includes a control system 320, seen in FIG. 7. The control system 320 includes a central controller 200 in communication with a plurality of unit controllers 190, either through a wired or wireless communication network.

Each unit controller 190 may take for example the form of a microcontroller that is operatively connected to both the wheel actuator motor 150 and the component actuator motor 162, and is capable of selectively actuating the latters according to local commands by the onboard microcontroller, or external commands provided by a central controller 200 of an automated storage and distribution warehouse via the communication network.

In some embodiments, the wheel actuator motors 150, the component actuator motors 162 and the unit controller 190 of the platform unit 100 are powered by an external electrical power source. Alternatively, the platform unit 100 may be powered by rechargeable onboard batteries.

For example, the central controller 200 may take the form of a computer system, shown in FIG. 7, programmed or otherwise configured to send instructions to the platform units 100, and more specifically the unit controllers 190, so that the latter can selectively control the platform units to move the items 300 therealong.

The central controller 200 includes a central processing unit (CPU, also “processor” and “computer processor” herein) 205, which can be a single core or multi core processor, or a plurality of processors for parallel processing. The central controller 202 also includes memory or memory location 210 (e.g., random-access memory, read-only memory, flash memory), electronic storage unit 215 (e.g., hard disk or solid state drive, among others), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The central controller 200 can in some embodiments be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the central controller 200, can implement a peer-to-peer network, which may enable devices coupled to the central controller 200 to behave as a client or a server. The interface 220 is also usable to send commands to the platform units 100 so that the latter can move items using the conveyors components 110. In some embodiments, the interface 220 can also receive information from the conveyors components 110, for example from load sensors 178 further described below. The unit controller 190 may also have a similar architecture, typically implemented in a low-cost computer or even a microcontroller, instead of having discrete chips and other components. The unit controller 190 also has components in its interface 220 suitable for delivering or controlling delivery of electrical power to the motors 162 and 150.

The CPU 205 can execute a sequence of machine-readable instructions, which can be embodied in a program or software. The instructions may be stored in a memory location, such as the memory 210. The instructions can be directed to the CPU 205, which can subsequently program or otherwise configure the CPU 205 to implement methods of the present disclosure. Examples of operations performed by the CPU 205 can include fetch, decode, execute, and writeback. The CPU 205 can be part of a circuit, such as an integrated circuit. One or more other components of the central controller 200 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The central controller 200 in some cases can include one or more additional data storage units that are external to the central controller 200, such as located on a remote server that is in communication with the central controller 200 through an intranet or the Internet. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can, in some embodiments, access the central controller 202 via the network 230.

Control of the platform units 100 is effected through executable code stored on an electronic storage location of the central controller 200 (and of the unit controllers 190), such as, for example, on the memory 210 or electronic storage unit 215. The machine executable or machine readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine having a processor adapted to execute the code, or can be compiled during runtime. The code can be supplied in a programming language that can be selected to enable the code to execute in a pre-compiled or as-compiled fashion. The code may provide a user interface allowing commands to be entered, and a control module controlling the dedicated interface, for example in the form of a device driver.

Aspects of the central controller 200 can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement databases. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The central controller 200 can include or be in communication with an electronic display 235 that comprises a user interface (UI) 240 for providing, for example, controls corresponding to the various operations that can be performed on the items 300 stored in the storage unit. In other embodiments, movements of the items 300 is instead determined through commands received from the interface 220 or from a database. Examples of UI's include, without limitation, a graphical user interface (GUI) and web-based user interface.

Non-limiting example of algorithms that may implemented in code executed by the central controller 200 to determine how to move the items 300 in the storage system 310 include the A* algorithms with the storage system 310 represented by a graph. The graph may represent the platform units 100 that are free (available to receive an item 300) as vertices, and their relationship as edges, with edges linking for example platform units 100 that can be reached by an item through transfer between adjacent platform units 100. If no path exists between two given platform units 100, such as would be the case with a high occupancy storage system 310, other items 300 may be moved to create such a path. The Dijkstra algorithm may be used if a shortest path is desired. In some embodiments, the central controller 202 may use a Simultaneous localization and mapping (SLAM) algorithm to map an environment in which the items 300 are to be moved.

Thus, an item 300, such as the one illustrated in FIG. 8, may be user selectively moved longitudinally and/or laterally along the platform unit 100, respectively relative to imaginary X and Y axis, by individually or concurrently actuating the wheel actuator motors 150 and the component actuator motors 162.

The platform unit 100 of the present invention is capable of moving parcels, boxes and/or palettes loaded with goods longitudinally along the imaginary X-axis 180, as well as laterally along the imaginary Y-axis 182, along a complex network of elongated and intersecting conveyor paths within and between shelved racking installations typically found in automated storage and distribution warehouses, as well as in transport truck, rail and maritime cargo containers.

With multiple platform units 100 assembled to form a relatively long and wide square or rectangular platform, the present invention is further capable of moving parcels, boxes and/or palettes along diagonal paths relative to a uniform or mixed alignment of the conveyor components 110 of each adjacent platform units 100 in the assembly. Thus, the platform unit 100 of the present invention provides an efficient and economic means for moving boxes, parcels, containers, loaded warehouse palettes and other goods from point A to point B.

For example, as illustrated in prior art images in FIGS. 9 to 12 inclusively, multiple platform units 100 of the present invention may be used throughout a fully computer automated storage and distribution warehouse and delivery truck system in a similar manner as the platform unit referenced 100′ in U.S. Pat. No. 12,227,363B2 Issued Feb. 18, 2025 to S. A. Mahriche.

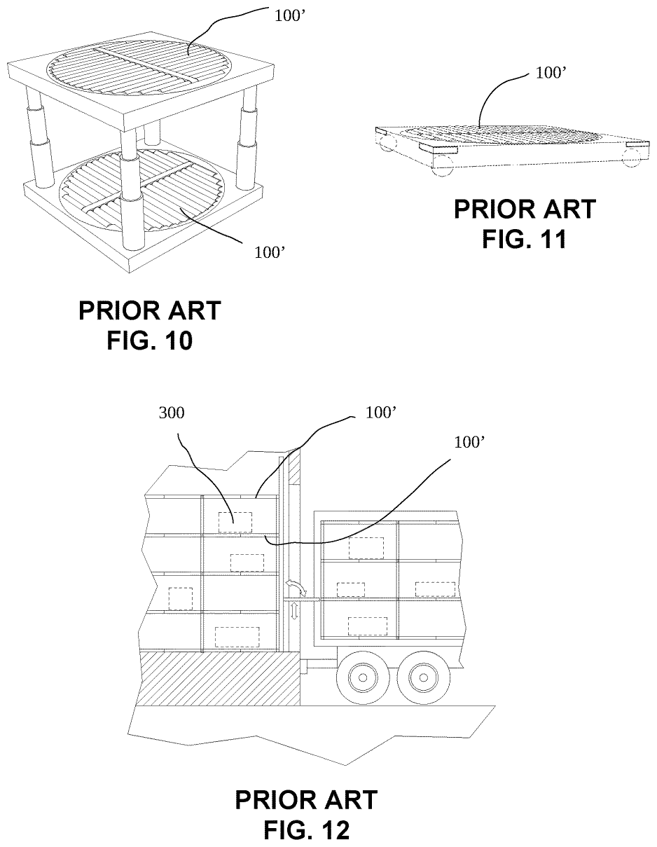

Importantly, as exemplified in FIG. 10, the platform unit referenced 100′ shown mounted on individually controlled telescopic cylinders, may be replaced with one or more platform units 100 of the present invention assembled in a side-by-side arrangement, as exemplified in FIG. 8.

Such grouped platform assemblies of platform units 100, in operative cooperation with individually controllable telescopic cylinders, or any equivalent vertical actuators, may be used to significantly increase the efficiency of transhipment operations of large groups of shipping boxes and/or loaded warehouse pallets 300 through controlled inclinations of the platform units 100.

It can be further considered that whole 18-wheelers delivery trucks may park on such assemblies of multiple platform units 100. The delivery truck may then be automatically relocated at an optimized location in register with a specific loading dock. A delivery truck provided with an assembly of multiple platform units 100 covering its trailer floor may then be slightly inclined in order to controllably accelerate the unloading operations thereof.

Still referring to FIG. 10, the inclination capabilities of the platform units 100 may further be advantageously used to impinge on a shipping box one more rotations around a vertical axis and/or a tilting action to one side, in order to have, for example, to shipping label facing up, and a predetermined orientation in a horizontal plan.

Further advantageously, the platform unit 100 of the present invention can be significantly more reliable and, thus, more cost effective, compared to automated platform units of the prior art comprising, for example, a plurality of individually actuated spherical rollers.

Further advantageously, the use of the platform unit 100 of the present invention throughout the warehouse consequently significantly reduces overall costs associated with spare parts, general maintenance, and training of employees operating the warehouse, comparatively to known automated equipments typically used for automating distribution warehouses and the likes.

Referring more particularly to FIG. 11, the platform unit 100 may just as well be provided with a set of multidirectional wheels, such as the four spherical wheels shown in the figure. Further provided with associated control unit and appropriate on board cameras and Lidar sensors for autonomous transport of goods, the platform unit 100 may autonomously move goods along narrow alleys between rows of high density storage racking in a warehouse. Such multidirectional wheels, cameras and sensors can also be provided on the telescopic platform units, such as the one shown in FIG. 10.

Thus equipped with multidirectional wheels, the platform unit 100 further allows the autonomous transport of, for example, a standard 4′ warehouse pallet loaded with goods through a tight 90 degree turn along a four feet wide corridor without having to rotate the pallet once at the junction of the right angle turn due to its ability to move laterally.

Referring to FIG. 8, in some embodiments, the invention storage system 310 includes assemblies 180 of four platform units 100.

Each one of the four platform units 100 in the assembly 180 is connected along a pair of adjacent edges thereof in a side by side relationship to two other platform units 100 in the assembly 180, such that the assembly 180 of four platform units 100 forms a substantially square or rectangular shaped planar assembly 180.

Furthermore, the longitudinal orientation of the conveyor components 110 of each platform unit 100 in the assembly 180 is perpendicular to the orientation of the conveyor components 110 of the two immediately adjacent, or contiguous, platform units 100.

Thus, for example, by concurrently actuating in a forward or reverse direction the conveyor components 110 of each platform units 100, a load 300 having a substantially planar underside surface resting in the center of the assembly 180, such as for example, a standard warehouse palette loaded with parcel boxes as illustrated, may be selectively rotated in one direction or the other relative to a vertical central axis 184 thereof, so as to be oriented in a predetermined direction.

Referring to FIGS. 2 and 8, in some embodiments, the platform unit 100 further comprises a load detector 178 operatively mounted respectively between each one of the conveyor component first and second end portions 112 and 114 and the platform frame 102. Each load detector 178 is operatively connected to at least one of the onboard microcontroller 190 and a remote control center of the automated warehouse via the communication means of the microcontroller 190.

When a load 300 is detected by a load detector 178, at least one of the respective wheel actuator motor 150 and component actuator motor 162 is actuated so as to allow the load 300 to be moved in a user selected direction. Thus, only the wheel actuator motors 150 and/or component actuator motors 162 corresponding to conveyor components 110 in contact with a load 300 are actuated. Thus, a significant economy of operational electrical power is achieved compared to know automated platform units of the prior art. The load detector may include load cells or optical signals for sensing the presence of a load in register with any given actuator component.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims. 26

What is claimed is

1. A storage system for handling items, comprising:
a plurality of platform units provided substantially adjacent and substantially coplanar relative to each other; and
a control system;
each platform unit including
a base;
a plurality of elongated conveyor components mounted to the base substantially parallel to each other and defining a first direction extending longitudinally relative to the conveyor components, the conveyor components being operative for selectively moving the items parallel to the base along the first direction, each conveyor component being also rotatable about a component rotation axis extending longitudinally relative thereto;
wherein the conveyor components are further operative for selectively moving the items parallel to the base along a second direction substantially perpendicular to the first direction when the conveyor components rotate about the component rotation axes;
wherein the control system is operative for selectively activating the conveyor components to move the items in the first and second directions on each of the platform units;
whereby the items can be selectively moved between the platform units by moving the items between adjacent ones of the platform units using the conveyor components.

2. The storage system as defined in claim 1, wherein each conveyor component includes a plurality of conveyor wheels longitudinally spaced apart from each other and each rotatable about a respective wheel rotation axis extending laterally to move the item along the first direction, the wheel rotation axes in each conveyor component being substantially parallel to each other.

3. The storage system as defined in claim 2, further including a wheel transmission coupling the conveyor wheels to each other for joint rotation about their respective wheel rotation axes.

4. The storage system as defined in claim 3, wherein each conveyor component further includes a component actuator operatively coupled to the wheel transmission and to the control system for rotating the conveyor wheels about their respective wheel rotation axes when powered by the control system.

5. The storage system as defined in claim 3, wherein the wheel transmission includes a belt and the wheels are configured to engage the belt so as to be rotatable thereby.

6. The storage system as defined in claim 2, wherein the conveyor wheels have a generally spherical configuration.

7. The storage system as defined in claim 2, wherein the conveyor wheels each include two substantially hemispherical wheel portions defining a gap therebetween, the gap containing a gear.

8. The storage system as defined in claim 3, wherein each platform unit further includes a component transmission coupling the conveyor components to each other for joint rotation about their respective component rotation axis.

9. The storage system as defined in claim 8, wherein each platform unit further includes a unit actuator operatively coupled to the component transmission and to the control system for rotating the conveyor component about their respective component rotation axes when powered by the control system.

10. The storage system as defined in claim 8, wherein the unit transmission includes a toothed belt engaging component gears, each component gear being rotatable about a respective one of the component rotation axes and jointly rotatable thereabout with a respective one of the conveyor components.

11. The storage system as defined in claim 1, wherein the storage system includes assemblies including four of the platform units arranged adjacent to each other in an array with the longitudinal axes of the conveyor components of each platform unit orthogonal to the longitudinal axes of the conveyor components of contiguous ones of the four platform units.

12. A platform unit for handling items, comprising:
a controller;
a base;
a plurality of elongated conveyor components mounted to the base substantially parallel to each other and defining a first direction extending longitudinally relative to the conveyor components, the conveyor components being operative for selectively moving the items parallel to the base along the first direction, each conveyor component being rotatable about a component rotation axis extending longitudinally relative thereto;
wherein the conveyor components are further operative for selectively moving the items parallel to the base along a second direction substantially perpendicular to the first direction when the conveyor components rotate about the component rotation axes; and
wherein the controller is operative for selectively activating the conveyor components to move the items in the first and second directions on each of the platform units.

13. The platform unit as defined in claim 12, wherein each conveyor component includes a plurality of conveyor wheels longitudinally spaced apart from each other and each rotatable about a respective wheel rotation axis extending laterally to move the item along the first direction, the wheel rotation axes in each conveyor component being substantially parallel to each other.

14. The platform unit as defined in claim 13, further including a wheel transmission coupling the conveyor wheels to each other for joint rotation about their respective wheel rotation axes.

15. The platform unit as defined in claim 14 wherein each conveyor component further includes a component actuator operatively coupled to the wheel transmission and to the controller for rotating the conveyor wheels about their respective wheel rotation axes when powered by the controller.

16. The platform unit as defined in claim 14, wherein the wheel transmission includes a belt and the wheels are configured to engage the belt so as to be rotatable thereby.

17. The platform unit as defined in claim 13, wherein the conveyor wheels have a generally spherical configuration.

18. The platform unit as defined in claim 13, wherein the conveyor wheels each include two substantially hemispherical wheel portions defining a gap therebetween, the gap containing a gear.

19. The platform unit as defined in claim 13, wherein each platform unit further includes a component transmission coupling the conveyor components to each other for joint rotation about their respective component rotation axes.

20. The platform unit as defined in claim 19, wherein each platform unit further includes a unit actuator operatively coupled to the component transmission and to the controller for rotating the conveyor components about their respective component rotation axes when powered by the controller.

21. The platform unit as defined in claim 20, wherein the component transmission includes a toothed belt engaging component gears, each component gear being rotatable about a respective one of the component rotation axes and jointly rotatable along with a respective one of the conveyor components.

22. The platform unit as defined in claim 12, further comprising a load detector for preventing actuation of the conveyor component in the absence of an item in register with the conveyor component.
